(19) United States
(12) Patent Application Publication
(10) Pub. No.: US 2003/0001866 A1
(43) Pub. Date: Jan. 2, 2003

(54) Method and computer program product for using a scrolling computer mouse to select pages of a set of linked web pages

(75) Inventors: Roger Bredow, Lawrenceville, GA (US); Jonathan Dunfee, Indianapolis, IN (US); James Everett Sapp, Doraville, GA (US); Matthew Bunkley Trevathan, Kennesaw, GA (US)

Correspondence Address: David R. Irvin, IBM Corporation T81/503, PO Box 12195, Research Triangle Park, NC, 27709, US

(73) Assignee: International Business Machines Corporation, Armonk, NY (US)

(21) Appl. No.: 09/896,802

(22) Filed: Jun. 29, 2001

(51) Int. Cl. G09G 5/00

(52) U.S. Cl. 345/660

(57) ABSTRACT

A scrolling mode for an Internet web browser, wherein a viewer controls the browser by operating the scrolling input mechanism of a scroll mouse, for example a scroll wheel. The viewer engages the scrolling mode while viewing one of a set of linked web pages. The browser awaits detection of scrolling output from the scroll mouse. When scrolling output is detected, the browser determines the sense of direction of the scrolling output. The browser then determines the URL of another of the pages in the set of linked web pages, and accesses that page. In one embodiment of the invention, the URL may be the URL that is associated with the page's previous button or next button. In another embodiment, the URL may be the URL that is associated with the browser's back button or forward button.

### FIELD OF THE INVENTION

The present invention applies generally to the Internet and World Wide Web, and more particularly to enabling a viewer to move conveniently from page to page among linked web pages by operating a scrolling computer mouse.

### BACKGROUND

In many important Internet applications, pages of the World Wide Web may be linked together, with the intention that a viewer may browse the pages as a set, progressing naturally through from one page to the next. For example, an on-line merchant may offer a catalog that displays a large selection of related products. A viewer may then flip through the product pages, so to speak, until a page comes up that catches his or her interest.

With today's technology, the viewer must go from page to page in a catalog by using a computer mouse to click on “previous” and “next” buttons that are displayed on the screen of a terminal. To do this, the mouse pointer must be located precisely upon these buttons, time after time, and the viewer must repeatedly click on the buttons. Often, this way of interacting with the catalog becomes tedious and annoying, as the mouse pointer may drift away from the buttons, and the viewer may tire from clicking the mouse or moving the mouse pointer to and fro. Further, the importance of having visual feedback while positioning the mouse pointer may divert the viewer's attention from the informative content of the page.

Consequently, there is a need for a convenient way of moving from page to page within a set of linked web pages, such as the pages of an on-line catalog, so that the viewer is not distracted by the burden of repeatedly clicking the mouse and repositioning its pointer, all the while keeping the pointer true upon the browser buttons while looking somewhere else on the web page.

### SUMMARY

The present invention provides a convenient way for a viewer to move from page to page within a set of web pages that are linked, and is suitable for browsing an on-line merchant's catalog or skipping through a list of search results returned by an Internet search engine.

According to the present invention, a scrolling mode for a web browser operates under the control of a scrolling computer mouse (a scroll mouse). A may viewer enter the scrolling mode while viewing one of the set of web pages, called here the “source page” for convenience. Scrolling mode may be entered, for example, by selecting an option from a menu, or by momentarily closing the right-side switch of a two-button computer mouse (making a “right click”), or the third switch of a three-switch mouse, or the third or forth switches of a four-switch mouse, and so forth. The browser then awaits detection of the viewer's scrolling input. In general, the viewer may enter scrolling input by operating the scrolling input mechanism of a scroll mouse, for example by rotating a scroll wheel. The sense of direction of the scrolling input is determined. For example, the direction may be forward when the viewer rotates the scroll wheel clockwise with respect to a reference, and backward when the viewer rotates the wheel counterclockwise. Responsive to the direction of the scrolling input, the browser then determines the URL of another page in the set of linked web pages, called here the “destination page,” and accesses that page. In one embodiment of the invention, the URL of the destination page may be the URL that is called by the source page's next button or previous button. In another embodiment of the invention, the URL of the destination page may be the URL that is available to the browser's forward button or back button.

Thus, with the present invention, the viewer may go conveniently from page to page in a set of linked web pages by operating the scrolling input mechanism of a scroll mouse, and need not be limited to clicking on previous and next or forward and back buttons. These and other aspects of the invention will be more fully appreciated when considered in the light of the following detailed description and drawings.

### BRIEF DESCRIPTION OF THE DRAWINGS

FIG. 1. shows an environment suitable for the present invention.

FIG. 2A shows an exemplary screen display created by a web browser.

FIG. 3. is a flowchart that shows aspects of the operation of the present invention.

### DETAILED DESCRIPTION

The present invention provides a scrolling mode for a web browser that enables a viewer to move conveniently from page to page within a set of web pages that are linked. The new scrolling mode is suitable for browsing an on-line merchant's catalog, skipping through a list of search results provided by an Internet search engine, examining a sequence of related or panoramic digital photographic images, and so forth. According to the present invention, the new scrolling mode operates under the control of a scrolling computer mouse (a scroll mouse).

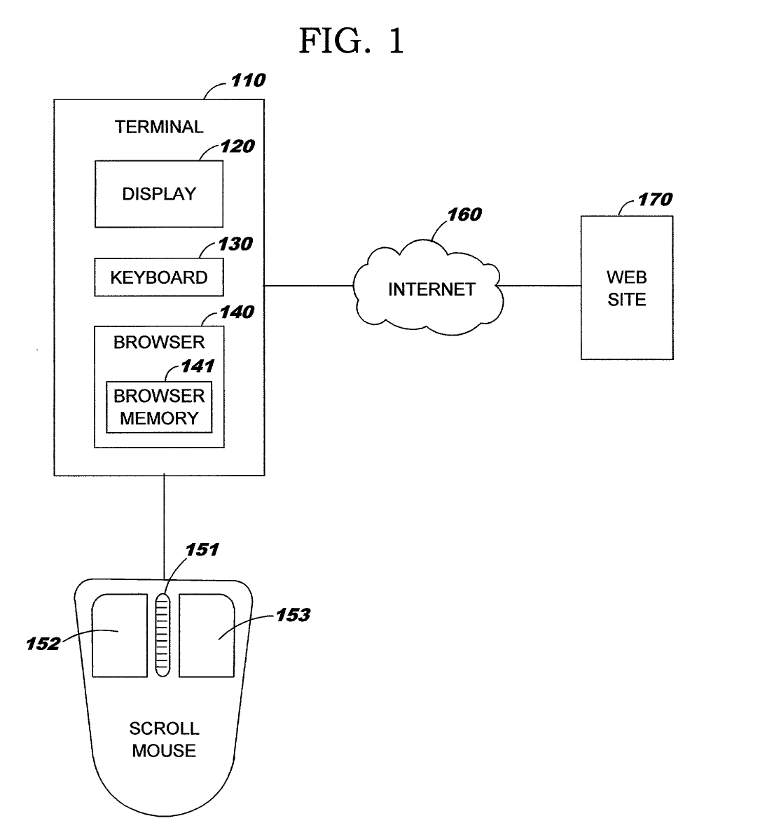

FIG. 1 shows an exemplary environment suitable for the present invention. In FIG. 1, an exemplary terminal 110 includes a visual display 120, a keyboard 130 or other input device such as a keypad, a stylus-selection apparatus, speech recognition apparatus, and so forth, a web browser 140 (as a descriptive convenience, the interchangeable terms “browser” and “web browser” are used here in an encompassing sense that includes many of the elements needed to operate a personal computer rather than just application-layer software), web browser memory 141 such as a cache, and a scroll mouse 150. The scroll mouse 150 may include a left-click switch 152, a right-click switch 153, and a scrolling input mechanism 151 such as a rotatable scroll wheel. A typical scroll mouse 150 is described in U.S. Pat. No. 5,530,455, the entirety of which is incorporated herein by reference. The terminal 110, which may be a personal computer, a personal digital assistant, a cellular telephone equipped with a web browser, and so forth, is connected by the Internet 160 or other communication network to a web site 170.

In a typical application, the viewer might use the terminal 110 to access an on-line merchant's home page on the World Wide Web. To access the home page, the viewer might use the keyboard 130 to enter a uniform resource locator (URL) into the web browser 140. The web browser 140 would then connect to the appropriate web site 170 via the Internet 160, and display the requested home page to the viewer on the display 120.

Typically, the home page would show a number of links to other pages. For example, the home page of an on-line merchant who sells wristwatches might offer links to catalogs that show watches made by several different manufacturers. One of these catalogs might comprise photographs and brief descriptions of M watches, spread over N web pages.

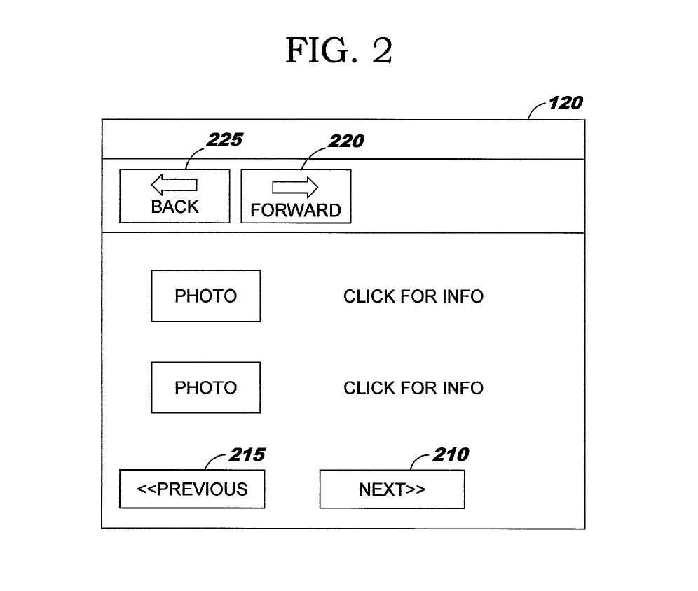

The N web pages of the catalog are a typical set of linked web pages. On the first page of such a set of linked web pages, a viewer may be presented with a button labeled “next,” as shown in FIG. 2. Clicking on the next button 210 calls up the second web page in the linked set. At the bottom of the second web page appear a next button 210 and a “previous” button 215. Clicking on the next button 210 of the second page calls up the third page of the set of linked pages; clicking on the previous button 215 of the second page recalls the first page. Generally, clicking on the next button 210 that appears on page K calls up page K+1, whereas clicking on the previous button 215 of page K calls up page K−1, where the page order, or sequence, is determined by the catalog provider.

In addition to product catalogs, a list of search results provided by an Internet search engine also may be a set of linked web pages when the list itself is too long to be displayed as a single page. Each page of a multi-page search list may include a next button 210 and a previous button 215, which the viewer clicks on to move through the pages of the list. The same general arrangement, the use of a next button 210 and a previous button 215, is also applicable to a wide range of other situations, for example the presentation of a sequence of digital photographic images, and is not limited to on-line shopping catalogs or Internet search lists. In these situations, the content provider, for example the merchant that provides the on-line catalog, explicitly determines the sequence provided by the links of the set of linked web pages.

A set of linked web pages and a sequence for that set may also be constructed implicitly by the viewer and the browser 140. For example, when the organization of the web site 170 does not lend itself to a catalog structure, the viewer often looks at various pages in a sequence determined by the viewer. The browser 140 may sequentially record the URLs of these pages (or hold the pages themselves) in the web browser memory 141, which may be a cache or other memory, and thereby create a set of linked web pages. The viewer may move through the set of linked web pages by clicking on a “forward” button 220 or a “back” button 225 provided by the browser 140 as shown in FIG. 2.

Thus the browser 140 may associate its forward button 220 and its back button 225 with the URLs of particular members of a set of linked web pages, where the association is determined implicitly by the past actions of the viewer as recorded in the browser memory 141, or may associate its next button 210 and its previous button 215 with the URLs of particular members of a set of linked web pages, where the association is determined explicitly by the web site. Based upon either of these associations, the viewer may move through the set of linked web pages, whether the sequence of the set is created explicitly by a web site or implicitly by the viewer, by clicking on the next button 210 and the previous button 215, or clicking on the forward button 220 and the back button 225, respectively.

Unfortunately, the method just described of moving through the set of linked web pages is sometimes awkward and therefore undesirable, as discussed earlier. In contrast, the present invention enables a viewer to move through a set of linked web pages more conveniently by using a scrolling mode for the browser 140. The new scrolling mode is controlled by the scrolling output of a scroll mouse 150 operated by the viewer.

The viewer may enter and exit the scrolling mode of the present invention by selecting from a menu of options, or by clicking with the right-click switch 153 of the scroll mouse 150, or by clicking with a third-click or fourth-click switch of a multi-switch scroll mouse, or by spoken command when speech-recognition apparatus is available, and so forth. When scrolling mode is active, the scroll mouse 150 provides scrolling output in response to the viewer's manipulation of the scrolling mechanism 151. The scrolling mechanism 151 may be a rotatable scroll wheel, a scroll lever, a jog wheel that is mounted, for example, on the side of a hand-held device such as a web-enabled cellular telephone, and so forth.

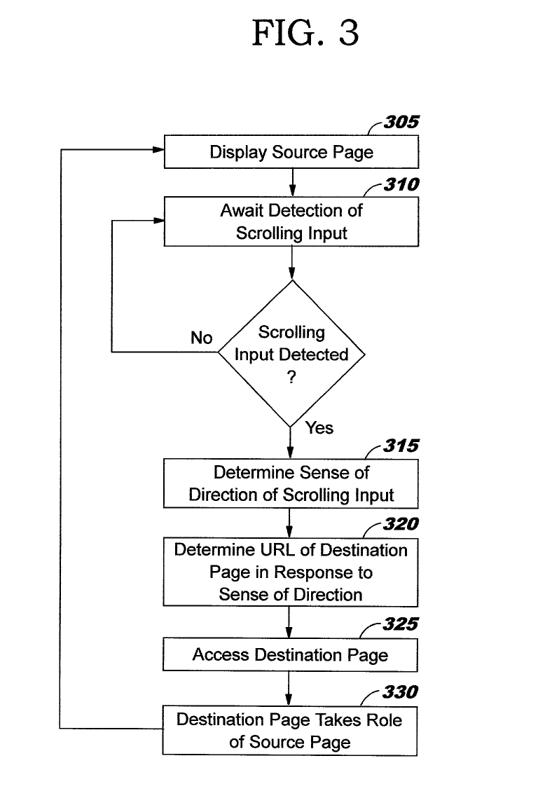

As shown in FIG. 3, the browser 140 displays the source page (step 305). The source page may be any member of the set of linked web pages—the word “source” is used here only to indicate that the page is presently displayed and that the viewer may move away from the presently displayed page to any other page that is a member of the set of linked web pages. Said other page is called here the “destination page.” Thus, the source page is the page moved from, and the destination page is the page moved to, where both the source page and the destination page are members of the set of linked web pages; the terms source page and destination page as used here have no other special meaning.

While displaying the source page, the browser 140 awaits detection of scrolling output from the scroll mouse 150 (step 310). If scrolling output is not detected, the browser 140 continues to await scrolling output or other instructions (step 310). Otherwise (i.e., scrolling output is detected), a sense of direction of the scrolling output is determined (step 315). Here, directional convention is unimportant, and may be assigned according to the nature of the scrolling input mechanism 151 and the preference of the viewer. For example, when the scrolling input mechanism 151 is a rotatable scroll wheel, rotation of the wheel by extension of the index finger of a right-handed viewer who is grasping the mouse conventionally may be defined as “forward,” and opposite rotation of the wheel may be defined as “backward.”

Responsive to the sense of direction of the scrolling output, the URL of the destination page is determined (step 320). When the sense of direction is forward, the URL of the destination page may be the URL associated with the next button 210 or the forward button 220; when the sense of direction is backward, the URL of the destination page may be the URL associated with the previous button 215 or the back button 225. The browser 140 accesses the destination page (step 325) through the Internet 160. At this point, the web page that was the destination page now takes the role of the source page (step 330), which the browser then displays (step 305).

From the foregoing description, those skilled in the art will recognize that the viewer may use the scrolling mode of the present invention to move conveniently thought a set of linked web pages without unproductive distraction. The foregoing description is illustrative rather than limiting, however, and the scope of the invention is limited only by the following claims.

We claim:

1. A method for browsing a set of linked web pages, comprising the steps of:
detecting scrolling output;
responsive to the scrolling output, determining a URL of a web page; and
accessing the web page by a web browser.

2. The method of claim 1, wherein the scrolling output is from a scroll mouse.

3. A method for using a scroll mouse to browse a set of linked web pages, comprising the steps of:
displaying a source page that is a member of a set of linked web pages;
detecting scrolling output of a scroll mouse while the source page is displayed;
determining a sense of direction of the scrolling output;
responsive to the sense of direction, determining a URL associated with a destination page that is a member of the set of linked web pages; and
accessing the destination web page by a web browser.

4. The method of claim 3, wherein the scroll mouse includes a scroll wheel.

5. The method of claim 3, wherein the set of linked pages includes an on-line catalog.

6. The method of claim 3, wherein the set of linked pages includes a search list provided by an Internet search engine.

7. The method of claim 3, wherein the set of linked pages is identified by a set of URLs held in web browser memory.

8. The method of claim 3, wherein the URL is associated with a next button of the source page when the sense of direction is forward and the URL is associated with a previous button of the source page when the sense of direction is backward.

9. The method of claim 3, wherein the URL is associated with a forward button of a web browser when the sense of direction is forward and the URL is associated with a back button of the web browser when the sense of direction is backward.

10. The method of claim 3, wherein the URL is the URL associated with a next button of the source page.

11. The method of claim 3, wherein the URL is the URL associated with a previous button of the source page.

12. The method of claim 3, wherein the URL is the URL associated with a forward button of the web browser.

13. The method of claim 3, wherein the URL is the URL associated with a back button of the web browser.

14. Programmable media containing programmable software for browsing of a set of linked web pages, comprising the steps of:
detecting scrolling output;
responsive to the scrolling output, determining a URL of a web page; and
accessing the web page with a web browser.

15. The programmable media containing programmable software of claim 14, wherein the scrolling output is from a scroll mouse.

16. Programmable media containing programmable software for browsing of a set of linked web pages using a scroll mouse, comprising the steps of:
displaying a source page that is a member of a set of linked web pages;
detecting scrolling output generated by a scroll mouse while the source page is displayed;
determining a sense of direction of the scrolling output;
responsive to the sense of direction, determining a URL associated with a destination page that is a member of the set of linked web pages; and
accessing the destination web page.

17. The programmable media containing programmable software of claim 16, wherein the scroll mouse includes a scroll wheel.

18. The programmable media containing programmable software of claim 16, wherein the set of linked pages includes an on-line catalog.

19. The programmable media containing programmable software of claim 16, wherein the set of linked pages includes a search list provided by an Internet search engine.

20. The programmable media containing programmable software of claim 16, wherein the set of linked pages is identified by a set of URLs held in web browser memory.

21. The programmable media containing programmable software of claim 16, wherein the URL is associated with a next button of the source page when the sense of direction is forward and the URL is associated with a previous button of the source page when the sense of direction is backward.

22. The programmable media containing programmable software of claim 16, wherein the URL is associated with a forward button of a web browser when the sense of direction is forward and the URL is associated with a back button of the web browser when the sense of direction is backward.

23. The programmable media containing programmable software of claim 16, wherein the URL is the URL associated with a next button of the source page.

24. The programmable media containing programmable software of claim 16, wherein the URL is the URL associated with a previous button of the source page.

25. The programmable media containing programmable software of claim 16, wherein the URL is the URL associated with a forward button of the web browser.

26. The programmable media containing programmable software of claim 16, wherein the URL is the URL associated with a back button of the web browser.
